(19) United States
(12) Patent Application Publication
(10) Pub. No.: US 2021/0259319 A1
(43) Pub. Date: Aug. 26, 2021

(54) Inhalation System, An Inhalation Device And A Vapour Generating Article

(71) Applicant: JT International S.A., Geneva (CH)

(72) Inventors: Andrew Robert John Rogan, Forres (GB); Lubos Brvenik, Krpelany (SK)

(73) Assignee: JT International S.A., Geneva (CH)

(21) Appl. No.: 17/054,047

(22) PCT Filed: May 15, 2019
(86) PCT No.: PCT/EP2019/062510

§ 371 Date: Nov. 9, 2020

(30) Foreign Application Priority Data
May 21, 2018 (EP) 18173398.1
May 21, 2018 (EP) 18173404.7
May 21, 2018 (EP) 18173406.2
Jun. 8, 2018 (EP) 18176708.8
Jun. 8, 2018 (EP) PCT/EP2018/065155
Oct. 18, 2018 (EP) 18201152.8

(51) Int. Cl. A24F 40/57; A24F 40/46; A24F 40/465; A24F 40/20; A24F 40/42; H05B 6/10; H01H 37/74; H01H 37/64

(52) U.S. Cl. CPC A24F 40/57; A24F 40/46; A24F 40/465; H01H 37/64; A24F 40/42; H05B 6/105; H01H 37/74; A24F 40/20

(57) ABSTRACT

An inhalation system for generating a vapour for inhalation by a user includes an inhalation device including a controller and a vapour generating article including a vapour generating material and a heating element. The controller is configured to provide a power supply profile adapted for a single use of the vapour generating article and having at least two sections with differing values of intensity per unit time of power supplied to the heating element. During a first section, the intensity per unit time of power supplied to the heating element has a first value arranged to maintain a target temperature at which a vapour is generated due to heating of the vapour generating material. During a second section, the intensity per unit time of power supplied to the heating element has a second value which is higher than the first value. The heating element is arranged to be broken to thereby break its electrical path when the second value of intensity per unit time of power has been supplied to the heating element a predetermined number of times.

### TECHNICAL FIELD

The present disclosure relates to an inhalation system for generating a vapour for inhalation by a user. Embodiments of the present disclosure also relate to an inhalation device and to a vapour generating article.

### TECHNICAL BACKGROUND

Devices which heat, rather than burn, a vapour generating material to produce a vapour or aerosol for inhalation have become popular with consumers in recent years. Such devices can use one of a number of different approaches to provide heat to the vapour generating material.

One approach is to provide an inhalation device which employs a resistive heating system. In such a device, a resistive heating element is provided to heat the vapour generating material and a vapour or aerosol is generated as the vapour generating material is heated by heat transferred from the heating element.

Another approach is to provide an inhalation device which employs an induction heating system. In such a device, an induction coil is provided with the device and a susceptor is provided typically with the vapour generating material. Electrical energy is provided to the induction coil when a user activates the device which in turn generates an alternating electromagnetic field. The susceptor couples with the electromagnetic field and generates heat which is transferred, for example by conduction, to the vapour generating material and a vapour or aerosol is generated as the vapour generating material is heated.

Whichever approach is used to heat the vapour generating material, it can be convenient to provide the vapour generating material in the form of a vapour generating article which can be inserted by a user into the inhalation device. Such vapour generating articles are typically intended for a single use, i.e., for use during a single session. If a previously used vapour generating article is re-used during a subsequent session, the characteristics of the vapour are often sub-optimal due to depletion of the vapour generating material and other constituents as a result of heating during the previous session. There is, therefore, a need to address this difficulty.

### SUMMARY OF THE DISCLOSURE

According to a first aspect of the present disclosure, there is provided an inhalation system for generating a vapour for inhalation by a user, the inhalation system comprising:
an inhalation device including a controller; and
a vapour generating article comprising a vapour generating material and a heating element;
wherein:
the controller is configured to provide a power supply profile adapted for a single use of the vapour generating article and having at least two sections with differing values of intensity per unit time of power supplied to the heating element in which:
   during a first section, the intensity per unit time of power supplied to the heating element has a first value arranged to maintain a target temperature at which a vapour is generated due to heating of the vapour generating material;
   during a second section, the intensity per unit time of power supplied to the heating element has a second value which is higher than the first value;
the heating element is arranged to be broken to thereby break its electrical path when the second value of intensity per unit time of power has been supplied to the heating element a predetermined number of times.

According to a second aspect of the present disclosure, there is provided an inhalation device, for use with a vapour generating article comprising a vapour generating material and a heating element, for generating a vapour for inhalation by a user, the inhalation device including a controller, wherein:
the controller is configured to provide a power supply profile adapted for a single use of the vapour generating article and having at least two sections with differing values of intensity per unit time of power supplied, in use, to the heating element in which;
   during a first section, the intensity per unit time of power supplied, in use, to the heating element has a first value arranged to maintain a target temperature at which a vapour is generated due to heating of the vapour generating material;
   during a second section, the intensity per unit time of power supplied, in use, to the heating element has a second value which is higher than the first value; and
the heating element is arranged to be broken to thereby break its electrical path when the second value of intensity per unit time of power has been supplied to the heating element a predetermined number of times.

The inhalation system/device is adapted to heat the vapour generating material, without burning the vapour generating material, to volatise at least one component of the vapour generating material and thereby generate a vapour or aerosol for inhalation by a user of the inhalation system/device.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

By controlling the operation of the inhalation system/device to provide a power supply profile with at least first and second sections with first and second values of intensity per unit time of the power supplied and by providing a heating element which is arranged to be broken when the second value of intensity per unit time of power has been supplied to the heating element a predetermined number of times, re-use of a vapour generating article can be prevented through breakage of the heating element and consequent breakage of its electrical path. Embodiments of the present disclosure thus provide a simple and convenient way to prevent re-use of a vapour generating article to thereby avoid the generation of undesirable flavour compounds from previously heated vapour generating material within the same vapour generating article.

The heating element may have a weakened part. The weakened part may have a higher electrical resistance than other parts of the heating element. The weakened part may be arranged to be broken when the second value of intensity per unit time of power has been supplied to the heating element said predetermined number of times. With this arrangement, breakage of the heating element at the appropriate time is assured thereby ensuring that the system operates reliably to prevent re-use of a vapour generating article.

The weakened part may have a smaller cross-sectional area than other parts of the heating element. The weakened part may have a smaller cross-sectional than other parts of the heating element in a plane perpendicular to a direction of current flow through the heating element. The weakened part of the heating element can be easily created by a simple reduction in the cross-sectional area of the heating element and the level of weakness can be easily controlled by appropriate selection of the cross-sectional area thereby allowing the operation of the inhalation system to be optimised.

The weakened part may comprise a first material and the other parts of the heating element may comprise a second material which may have a lower electrical resistance than the first material. The weakened part of the heating element can be easily created by appropriately selecting the first and second materials and the level of weakness can be easily controlled allowing the operation of the inhalation system to be optimised.

In some embodiments, the heating element may comprise a resistive heating element. Thus, the vapour generating article may comprise a vapour generating material and a resistive heating element.

In some embodiments, the heating element may comprise an inductively heatable susceptor. Thus, the vapour generating article may comprise a vapour generating material and an inductively heatable susceptor.

The inductively heatable susceptor may comprise a ring-shaped susceptor and may include a non-concentric aperture or a slit. The non-concentric aperture or slit provides a reduced cross-sectional area and, thus, acts as the weakened part of the heating element. The weakened part can, therefore, be easily created and the level of weakness can be easily controlled allowing the operation of the inhalation system to be optimised.

The inductively heatable susceptor may comprise a tubular susceptor. The tubular susceptor may be formed by a wrapped sheet having free edges which are connected by a joint, the joint having an electrical resistance which is higher than an electrical resistance of the sheet. The higher electrical resistance of the joint means that the joint acts as the weakened part and the joint can thus be exploited to prevent re-use of the vapour generating article. The joint may, for example, be an adhesive joint which comprises an electrically conductive adhesive adhering free edges, possibly overlapping free edges, of the sheet to each other. The joint may alternatively be a welded joint or may be a soldered joint. The weakened part can be easily created and the level of weakness can be easily controlled allowing the operation of the inhalation system to be optimised.

The inductively heatable susceptor may comprise one or more, but not limited, of aluminium, iron, nickel, stainless steel and alloys thereof, e.g. Nickel Chromium or

Nickel Copper. With the application of an electromagnetic field in its vicinity, the susceptor may generate heat due to eddy currents and magnetic hysteresis losses resulting in a conversion of energy from electromagnetic to heat.

The inhalation system/device may comprise an induction coil arranged to generate an electromagnetic field. The inductively heatable susceptor is inductively heatable in the presence of the electromagnetic field.

The induction coil may comprise a Litz wire or a Litz cable. It will, however, be understood that other materials could be used. The induction coil may be substantially helical in shape and may, for example, extend around a space in which the vapour generating article is received in use.

The circular cross-section of a helical induction coil may facilitate the insertion of the vapour generating article into the inhalation system/device, for example into the space in which the vapour generating article is received in use, and may ensure uniform heating of the vapour generating material.

The induction coil may be arranged to operate in use with a fluctuating electromagnetic field having a magnetic flux density of between approximately 20 mT and approximately 2.0 T at the point of highest concentration.

The inhalation system/device may include a power source and circuitry which may be configured to operate at a high frequency. The power source and circuitry may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The physical phenomenon resulting from the breakage of the inductively heatable susceptor, such as an absence of an expected increase in the temperature of the inductively heatable susceptor, may be detected by the controller. The controller may be configured to indicate to a user, based on the detected physical phenomenon, that the vapour generating article has been used previously and is unsuitable for use further use and/or to cease the supply of power to the induction coil.

The controller may be configured to provide a power supply profile comprising one first section and one second section which occurs before the first section and during which the vapour generating material is heated to the target temperature. The heating element may be arranged to be broken to thereby break its electrical path during a second instance of the second section when the second value of intensity per unit time of power is supplied to the heating element for a second time. With this arrangement, because the second section with the second (higher) value of power intensity per unit time occurs before the first section, re-use of a vapour generating article is prevented due to breakage of the heating element, and hence breakage of the electrical path, at the beginning of a subsequent session using the same vapour generating article. A simple power supply profile (and hence heating profile) can be implemented with this arrangement because the primary purpose of the second section (during which breakage of the heating element may occur) is to heat the vapour generating material to the target temperature. Thus, the need for a power supply profile (and hence heating profile) which is specifically adapted to break the heating element can be avoided.

The controller may be configured to provide a power supply profile comprising one first section and one second section which occurs after the first section. The heating element may be arranged to be broken to thereby break its electrical path during a first instance of the second section when the second value of intensity per unit time of power is supplied to the heating element for a first time. With this arrangement, because the second section with the second (higher) value of power intensity per unit time occurs after the first section, breakage of the heating element, and hence breakage of the electrical path, occurs at the end of a session thereby preventing re-use of the same vapour generating article during a subsequent session. Because the second section is specifically adapted to break the heating element, the relationship between the second value of intensity per unit time of the power supplied to the heating element and the structure of the heating element, for example the weakened part, can be carefully controlled to ensure that the heating element is broken during the second section to prevent re-use of the vapour generating article during a subsequent session.

The controller may be configured to provide a power supply profile comprising a plurality of said first and second sections. The heating element may be arranged to be broken to thereby break its electrical path after a predetermined number of instances of the second section when the second value of intensity per unit time of power has been supplied to the heating element a predetermined number of times. With this arrangement, breakage of the heating element, and hence breakage of the electrical path, occurs at the end of a session thereby preventing re-use of the same vapour generating article during a subsequent session. For example, the relationship between the second value of intensity per unit time of the power supplied to the heating element and the structure of the heating element, for example the weakened part, can be carefully controlled to ensure that the heating element is broken after the second value of intensity per unit time of power has been supplied to the heating element a predetermined number of times. The predetermined number of times could correspond to a predetermined number of inhalations (or puffs) by a user of the inhalation system/device, for example due to activation of the heating element in response to a control signal from an air flow sensor (or puff detector) or in response to a manual activation of the heating element by a user of the inhalation system/device. The predetermined number of inhalations (or puffs) may be between 5 and 50, may typically be between 5 and 20 and is more typically between 10 and 20.

The vapour generating material may be any type of solid or semi-solid material. Example types of vapour generating solids include powder, granules, pellets, shreds, strands, particles, gel, strips, loose leaves, cut filler, porous material, foam material or sheets. The vapour generating material may comprise plant derived material and in particular, may comprise tobacco. The vapour generating material may alternatively comprise a vapour generating liquid.

The vapour generating material may comprise an aerosol-former. Examples of aerosol-formers include polyhydric alcohols and mixtures thereof such as glycerine or propylene glycol. Typically, the vapour generating material may comprise an aerosol-former content of between approximately 5% and approximately 50% on a dry weight basis. In some embodiments, the vapour generating material may comprise an aerosol-former content of approximately 15% on a dry weight basis.

The vapour generating article may comprise an air-permeable shell containing vapour generating material. The air permeable shell may comprise an air permeable material which is electrically insulating and non-magnetic. The material may have a high air permeability to allow air to flow through the material with a resistance to high temperatures. Examples of suitable air permeable materials include cellulose fibres, paper, cotton and silk. The air permeable material may also act as a filter. Alternatively, the vapour generating article may comprise a vapour generating material wrapped in paper. Alternatively, the vapour generating material may be contained inside a material that is not air permeable, but which comprises appropriate perforations or openings to allow air flow. The vapour generating material may be formed substantially in the shape of a stick.

According to a third aspect of the present disclosure, there is provided a vapour generating article comprising a non-liquid vapour generating material and a heating element having a weakened part which is arranged to be broken at the end of a first use or at the beginning of a second use of the article.

The weakened part may have a higher electrical resistance than other parts of the heating element.

The vapour generating article and/or the heating element may comprise one or more of the features defined above.

As explained above, it may be desirable to prevent re-use of the vapour generating article to avoid the generation of undesirable flavour compounds from previously heated vapour generating material within the same vapour generating article. The provision of a heating element with a weakened part facilitates this goal, by preventing current flow through the heating element due to a simple breakage process and thereby ensuring that the generation of undesirable flavour compounds from previously heated vapour generating material within the same vapour generating article is prevented either at the end of a first use or at the beginning of a second use of the article.

### BRIEF DESCRIPTION OF THE DRAWINGS

FIG. 1 is a diagrammatic view of an example of an inhalation system comprising an inhalation device and a first example of a vapour generating article;

FIG. 2a is a diagrammatic view of a second example of a vapour generating article;

FIG. 2b is a cross-sectional view along the line A-A in FIG. 2a;

FIG. 2c is a cross-sectional view along the line B-B in FIG. 2a;

FIGS. 3a to 3c are examples of ring-shaped heating elements suitable for the vapour generating articles of FIGS. 1 and 2;

FIG. 4 is a diagrammatic perspective view of a third example of a vapour generating article having a tubular heating element;

FIG. 5 is a diagrammatic cross-sectional view along the line C-C shown in FIG. 4;

FIG. 6 is a graphical representation of a first example of a power supply profile and resultant heating profile;

FIG. 7 is a graphical representation of a second example of a power supply profile and resultant heating profile; and

FIG. 8 is a graphical representation of a second example of a power supply profile and resultant heating profile.

### DETAILED DESCRIPTION OF EMBODIMENTS

Embodiments of the present disclosure will now be described by way of example only and with reference to the accompanying drawings.

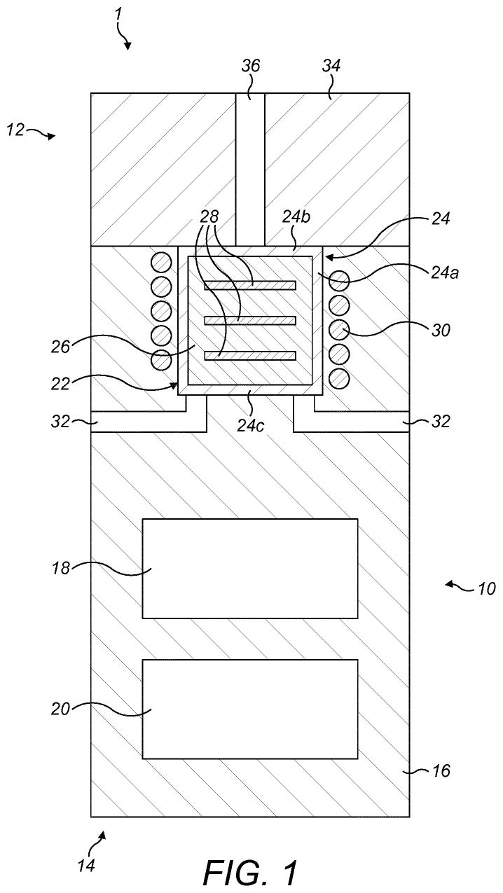

Referring initially to FIG. 1, there is shown diagrammatically an example of an inhalation system 1. The inhalation system 1 comprises an inhalation device 10 and a first example of a vapour generating article 24. The inhalation device 10 has a proximal end 12 and a distal end 14 and comprises a device body 16 which includes a power source 18 and a controller 20 which may be configured to operate at high frequency. The power source 18 typically comprises one or more batteries which could, for example, be inductively rechargeable.

The inhalation device 10 is generally cylindrical and comprises a generally cylindrical vapour generating space 22, for example in the form of a heating compartment, at the proximal end 12 of the inhalation device 10. The cylindrical vapour generating space 22 is arranged to receive a correspondingly shaped generally cylindrical vapour generating article 24 containing a vapour generating material 26 and one or more induction heatable susceptors 28. The vapour generating article 24 typically comprises a non-metallic cylindrical outer shell 24a and an air-permeable layer or membrane 24b, 24c at the proximal and distal ends to contain the vapour generating material 26 and allow air to flow through the vapour generating article 24. The vapour generating article 24 is a disposable article which may, for example, contain tobacco as the vapour generating material 26.

The inhalation device 10 comprises a helical induction coil 30 which has a circular cross-section and which extends around the cylindrical vapour generating space 22. The induction coil 30 can be energised by the power source 18 and controller 20. The controller 20 includes, amongst other electronic components, an inverter which is arranged to convert a direct current from the power source 18 into an alternating high-frequency current for the induction coil 30.

The inhalation device 10 includes one or more air inlets 32 in the device body 16 which allow ambient air to flow into the vapour generating space 22. The inhalation device 10 also includes a mouthpiece 34 having an air outlet 36. The mouthpiece 34 is removably mounted on the device body 16 at the proximal end 12 to allow access to the vapour generating space 22 for the purposes of inserting or removing a vapour generating article 24.

As will be understood by one of ordinary skill in the art, when the induction coil 30 is energised during use of the inhalation system 1, an alternating and time-varying electromagnetic field is produced. This couples with the one or more induction heatable susceptors 28 and generates eddy currents and/or magnetic hysteresis losses in the one or more induction heatable susceptors 28 causing them to heat up. The heat is then transferred from the one or more induction heatable susceptors 28 to the vapour generating material 26, for example by conduction, radiation and convection.

The induction heatable susceptor(s) 28 can be in direct or indirect contact with the vapour generating material 26, such that when the susceptor(s) 28 is/are inductively heated by the induction coil 30, heat is transferred from the susceptor(s) 28 to the vapour generating material 26, to heat the vapour generating material 26 and thereby produce a vapour or aerosol. The vaporisation of the vapour generating material 26 is facilitated by the addition of air from the surrounding environment through the air inlets 32. The vapour generated by heating the vapour generating material 26 exits the vapour generating space 22 through the air outlet 36 where it can be inhaled by a user of the device 10. The flow of air through the vapour generating space 22, i.e. from the air inlets 32, through the vapour generating space 22 and out of the air outlet 36, can be aided by negative pressure created by a user drawing air from the air outlet 36 side of the inhalation device 10.

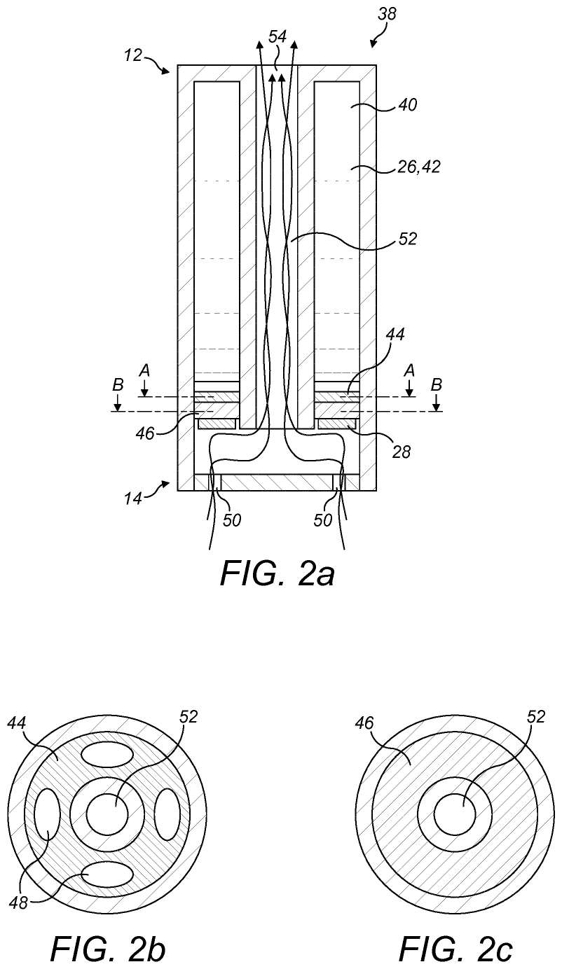

Referring now to FIGS. 2a to 2c, there is shown a second example of a vapour generating article 38 for use with an inhalation system which may be similar to the inhalation system described above with reference to FIG. 1. The vapour generating article 38 shares some similarities with the vapour generating article 24 described above with reference to FIG. 1 and corresponding elements are identified using corresponding reference numerals.

The vapour generating article 38 comprises a reservoir 40 for storing vapour generating material 26 in the form of a vapour generating liquid 42, for example comprising glycerine or propylene glycol. The vapour generating article 38 further comprises a porous member 44 and a liquid absorbing element 46, for example comprising a liquid absorbing material such as cotton. The porous member 44 comprises a disc formed of a plastics material and having a plurality of openings 48. The liquid absorbing element 46 also comprises a disc. The liquid absorbing element 46 receives a controlled flow of vapour generating liquid 42 directly from the reservoir 40 through the openings 48 in the porous member 44 so that the amount of vapour generating liquid 42 absorbed by the liquid absorbing element 46 is carefully controlled.

The vapour generating article 38 further comprises an induction heatable susceptor 28 which is positioned adjacent to, and possibly in contact with, the liquid absorbing element 46.

When the vapour generating article 38 is positioned in a vapour generating space of an inhalation system comprising a helical induction coil, the helical induction coil extends around the induction heatable susceptor 28. When the induction coil is energised during use of the inhalation system, an alternating and time-varying electromagnetic field is produced. This couples with the induction heatable susceptor 28 and generates eddy currents and/or magnetic hysteresis losses in the induction heatable susceptor 28 causing it to heat up. The heat is then transferred from the induction heatable susceptor 28 to the liquid absorbing element 46, for example by conduction, radiation and convection, to heat the vapour generating liquid 42 and thereby produce a vapour or aerosol. The vaporisation of the vapour generating liquid 42 is facilitated by the addition of air from the surrounding environment through air inlets 50. The vapour generated by heating the vapour generating liquid 42 flows along a vapour passage 52 where it cools and condenses to form a vapour or aerosol with optimum characteristics. The vapour or aerosol then exits the vapour passage 52 through an air outlet 54 where it can be inhaled by a user. The flow of air through the vapour generating article 38, i.e. through the air inlets 50, along the vapour passage 52 and out of the air outlet 54 is shown diagrammatically in FIG. 2a by the arrows and can be aided by negative pressure created by a user drawing air from the air outlet 54 side of the inhalation system.

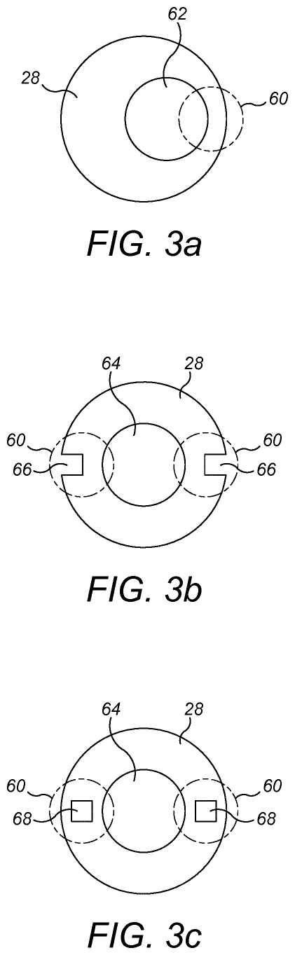

Referring now to FIGS. 3a to 3c, there are shown different examples of induction heatable susceptors 28 suitable for use with the vapour generating articles 24, 38 described above with reference to FIGS. 1 and 2. In each example, the induction heatable susceptor 28 has at least one weakened part 60 which has a higher electrical resistance than other parts of the induction heatable susceptor 28. The weakened part 60 is created by providing a part of the induction heatable susceptor 28 with a smaller cross-sectional area in a plane perpendicular to the current flow direction than other parts of the susceptor 28. As will be explained later in this specification, the higher electrical resistance of the weakened part 60 can be exploited to cause breakage of the induction heatable susceptor 28 at a predetermined time, thereby breaking its electrical path and preventing re-use of the vapour generating articles 24, 38.

In the example shown in FIG. 3a, induction heatable susceptor 28 is a ring-shaped susceptor 28 and includes a non-concentric aperture 62 thereby creating the weakened part 60 of smaller cross-sectional area. In the example shown in FIG. 3b, the induction heatable susceptor 28 is a ring-shaped susceptor with a concentric aperture 64 and includes a pair of slits 66 at diametrically opposite positions creating two weakened parts 60 of smaller cross-sectional area. In a variation of this example, a single slit 66 or more than two slits 66 could be provided. In the example shown in FIG. 3c, the induction heatable susceptor 28 is a ring-shaped susceptor with a concentric aperture 64 and includes a pair of openings 68 at diametrically opposite positions creating two weakened parts 60 of smaller cross-sectional area. In a variation of this example, a single opening 68 or more than two openings 68 could be provided.

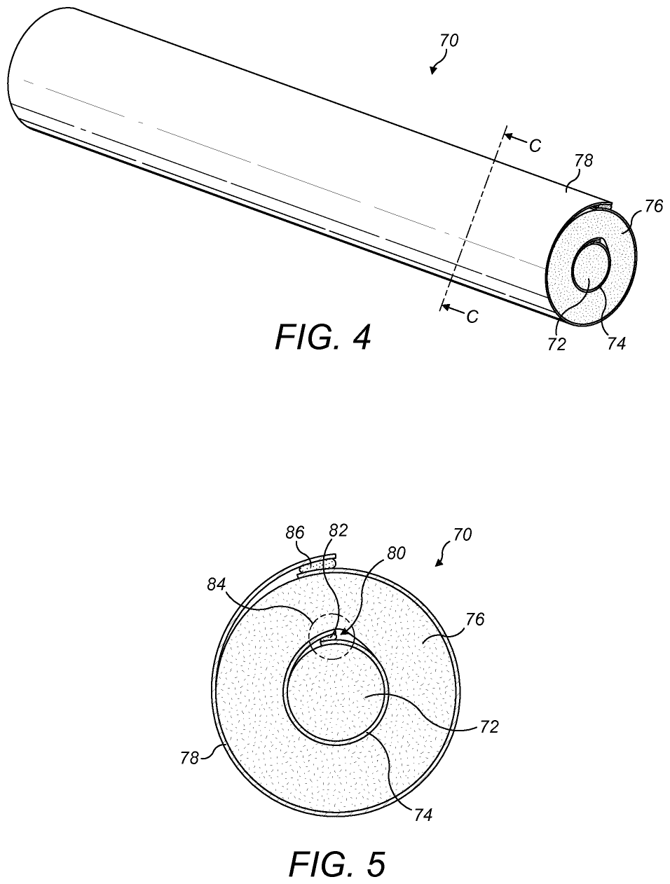

Referring now to FIGS. 4 and 5, there is shown a third example of a vapour generating article 70 for use with an inhalation system which may be similar to the inhalation system described above with reference to FIG. 1. The vapour generating article 70 is elongate and substantially cylindrical. The circular cross-section facilitates handling of the article 70 by a user and insertion of the article 70 into a vapour generating space of an inhalation device.

The vapour generating article 70 comprises a first body of vapour generating material 72, a tubular induction heatable susceptor 74 surrounding the first body of vapour generating material 72, a second body of vapour generating material 76 surrounding the tubular susceptor 74 and a tubular member 78 surrounding the second body of vapour generating material 76.

The tubular susceptor 74 is inductively heatable in the presence of a time varying electromagnetic field and comprises a metal wrapper formed of an inductively heatable susceptor material. The metal wrapper comprises a sheet of material (e.g. a second material), for example a metal foil, having longitudinally extending free edges and is rolled or wrapped to form the tubular susceptor 74. The tubular susceptor 74 has a longitudinally extending joint 80 which connects the opposite free edges of the wrapped sheet. In the illustrated example, the edges are arranged to overlap each other and are secured together by an electrically conductive adhesive 82 (e.g. a first material). The electrically conductive adhesive 82 typically comprises one or more adhesive components interspersed with one or more electrically conductive components. The metal wrapper and the electrically conductive adhesive 82 together form a closed electrical circuit which surrounds the first body of vapour generating material 72. The metal wrapper (comprising the second material) has a lower electrical resistance than the electrically conductive adhesive 82 (the first material) and, thus, the electrically conductive adhesive 82 with its higher electrical resistance provides a weakened part 84 which can be exploited to cause breakage of the tubular susceptor 74, thereby breaking its electrical path and preventing re-use of the vapour generating article 70.

When a time varying electromagnetic field is applied in the vicinity of the tubular susceptor 74 during use of the vapour generating article 70 in an inhalation device, heat is generated in the tubular susceptor 74 due to eddy currents and magnetic hysteresis losses and the heat is transferred from the tubular susceptor 74 to the adjacent first and second bodies of vapour generating material 72, 76 to heat the vapour generating material without burning it and to thereby generate a vapour or aerosol for inhalation by a user. The tubular susceptor 74 is in contact over substantially its entire inner and outer surfaces with the vapour generating material of the first and second bodies 72, 76 respectively, thus enabling heat to be transferred directly, and therefore efficiently, from the tubular susceptor 74 to the vapour generating material.

The tubular member 78 is concentric with the tubular susceptor 74 and comprises a paper wrapper. Although a paper wrapper may be preferred, the tubular member 78 can comprise any material which is substantially non-electrically conductive and non-magnetically permeable so that the tubular member 78 is not inductively heated in the presence of a time varying electromagnetic field during use of the article 70 in an inhalation device. The paper wrapper constituting the second tubular member 78 comprises a single sheet of material having longitudinally extending free edges which are arranged to overlap each other and which are secured together by an adhesive 86 which is substantially non-electrically conductive and non-magnetically permeable so that it is not inductively heated during use of the article 70 in an inhalation device.

The vapour generating material of the first and second bodies 72, 76 is typically a solid or semi-solid material. Examples of suitable vapour generating solids include powder, shreds, strands, porous material, foam material and sheets. The vapour generating material typically comprises plant derived material and, in particular, comprises tobacco.

The vapour generating material of the first and second bodies 72, 76 comprises an aerosol-former such as glycerine or propylene glycol. Typically, the vapour generating material may comprise an aerosol-former content of between approximately 5% and approximately 50% on a dry weight basis. Upon heating due to heat transfer from the tubular susceptor 74, the vapour generating material of both the first and second bodies 72, 76 releases volatile compounds possibly including nicotine or flavour compounds such as tobacco flavouring.

As mentioned above, the weakened part 60, 84 of the vapour generating articles 24, 38, 70 can be exploited to cause breakage of the susceptor 28, 74, thereby breaking its electrical path and preventing re-use of the vapour generating articles 24, 38, 70. In particular, the controller 20 of the inhalation device with which the vapour generating articles 24, 38, 70 is used is configured to provide a power supply profile adapted for a single use of the vapour generating articles 24, 38, 70. The power supply profile has at least two sections with differing values of intensity per unit time of power supplied to the induction heatable susceptor 28, 74 in which: during a first section, the intensity per unit time of power supplied to the induction heatable susceptor 28, 74 has a first value arranged to maintain a target temperature at which a vapour is generated due to heating of the vapour generating material 26, 72, 76; and during a second section, the intensity per unit time of power supplied to the induction heatable susceptor 28, 74 has a second value which is higher than the first value. The induction heatable susceptor 28, 74 is arranged to be broken to thereby break its electrical path when the second value of intensity per unit time of power has been supplied to the induction heatable susceptor 28, 74 a predetermined number of times. In preferred embodiments, breakage of the induction heatable susceptor 28, 74 occurs at the weakened part 60, 84 due to its higher electrical resistance than the other parts of the susceptor 28, 74.

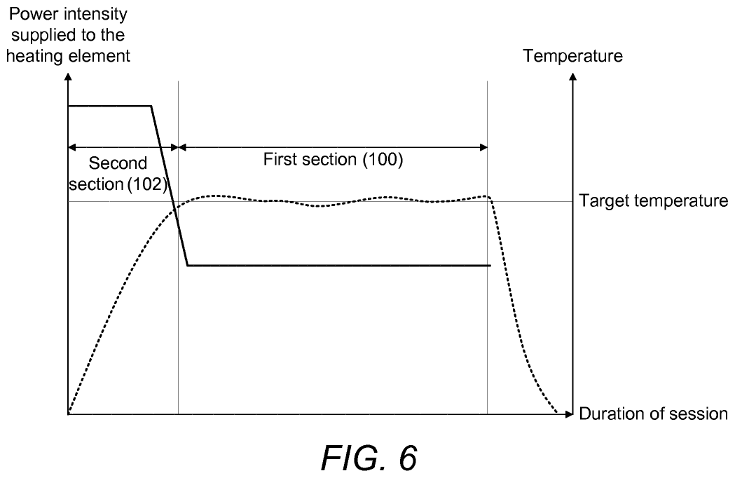

FIG. 6 illustrates a first example of a power supply profile and resultant heating profile which can be implemented by the controller 20. The solid line represents the power intensity supplied to the heating element (e.g. induction heatable susceptor 28, 74) and the dotted line represents the temperature of the vapour generating material 26, 72, 76. It will be seen from FIG. 6 that the controller 20 is configured to provide a power supply profile comprising one first section 100 and one second section 102. The second section 102 occurs before the first section 100 and it is during the second section 102 that the vapour generating material 26, 72, 76 is heated to the target temperature. In this example, the heating element (e.g. induction heatable susceptor 28, 74) is arranged to be broken to thereby break its electrical path during a second instance of the second section 102 when the second value of intensity per unit time of power is supplied to the heating element (e.g. induction heatable susceptor 28, 74) for a second time.

In this example, because the second section 102 with the second (higher) value of power intensity per unit time occurs before the first section 100, re-use of a vapour generating article is prevented due to breakage of the heating element (e.g. induction heatable susceptor 28, 74), and hence breakage of the electrical path, at the beginning of a subsequent session using the same vapour generating article.

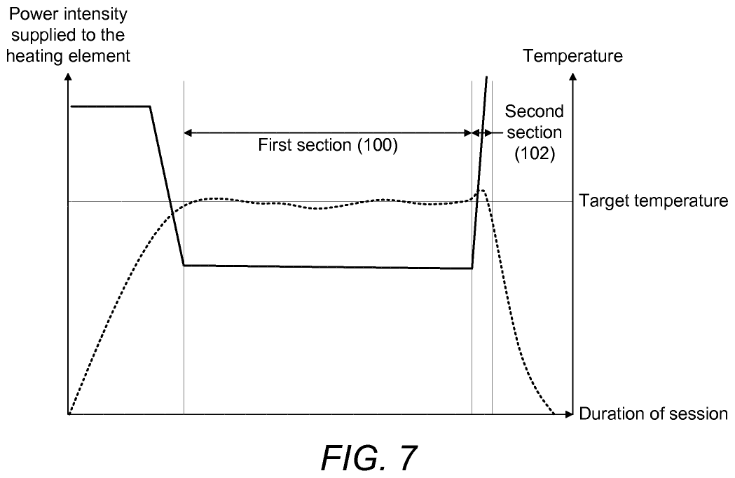

FIG. 7 illustrates a second example of a power supply profile and resultant heating profile which can be implemented by the controller 20. The solid line represents the power intensity supplied to the heating element (e.g. induction heatable susceptor 28, 74) and the dotted line represents the temperature of the vapour generating material 26, 72, 76. It will be seen from FIG. 7 that the controller 20 is configured to provide a power supply profile comprising one first section 100 and one second section 102. In this example, the second section 102 occurs after the first section 100 and the heating element (e.g. induction heatable susceptor 28, 74) is arranged to be broken to thereby break its electrical path during a first instance of the second section 102 when the second value of intensity per unit time of power is supplied to the heating element (e.g. induction heatable susceptor 28, 74) for a first time.

In this example, because the second section 102 with the second (higher) value of power intensity per unit time occurs after the first section 100, breakage of the heating element (e.g. induction heatable susceptor 28, 74), and hence breakage of the electrical path, occurs at the end of a session thereby preventing re-use of the same vapour generating article during a subsequent session.

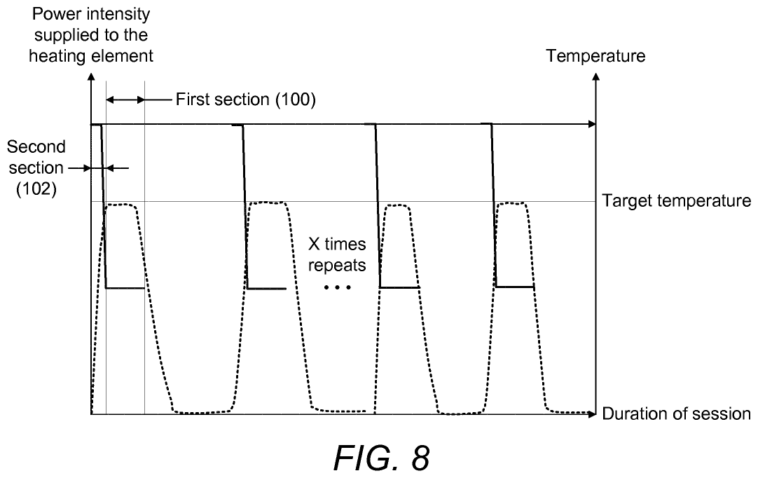

FIG. 8 illustrates a third example of a power supply profile and resultant heating profile which can be implemented by the controller 20. The solid line represents the power intensity supplied to the heating element (e.g. induction heatable susceptor 28, 74) and the dotted line represents the temperature of the vapour generating material 26, 72, 76. It will be seen from FIG. 8 that the controller 20 is configured to provide a power supply profile comprising multiple first and second sections 100, 102. In this example, the heating element (e.g. induction heatable susceptor 28, 74) is arranged to be broken to thereby break its electrical path after a predetermined number of instances of the second section 102 when the second value of intensity per unit time of power has been supplied to the heating element (e.g. induction heatable susceptor 28, 74) a predetermined number of times. The predetermined number of instances of the second section 102 typically corresponds to a predetermined number of inhalations (or puffs) by a user of the inhalation system/device, for example due to activation of the heating element (e.g. induction heatable susceptor 28, 74) in response to a control signal from an air flow sensor (or puff detector) (not shown) or in response to a manual activation of the heating element (e.g. induction heatable susceptor 28, 74) by a user of the inhalation system/device.

In this example, breakage of the heating element (e.g. induction heatable susceptor 28, 74), and hence breakage of the electrical path, occurs at the end of a session thereby preventing re-use of the same vapour generating article during a subsequent session.

In any one of the above examples, the physical phenomenon resulting from the breakage of the induction heatable susceptor 28, 74, such as an absence of an expected increase in the temperature of the induction heatable susceptor 28, 74, can be detected and exploited by the controller 20. For example, the controller 20 can be configured to indicate to a user, based on the detected physical phenomenon, that the vapour generating article 24, 38, 70 has been used previously and is unsuitable for further use, for example by providing an audible and/or visual and/or tactile alert. Alternatively or in addition, the controller 20 can be configured, based on the detected physical phenomenon, to cease the supply of power to the induction coil 30 by the power source 18, thereby preventing re-use of the vapour generating article 24, 38, 70.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An inhalation system for generating a vapour for inhalation by a user,
the inhalation system comprising:
an inhalation device including a controller; and
a vapour generating article comprising a vapour generating material and a heating element;
wherein:
the controller is configured to provide a power supply profile adapted for a single use of the vapour generating article and having at least two sections with differing values of intensity per unit time of power supplied to the heating element in which:
during a first section, the intensity per unit time of power supplied to the heating element has a first value arranged to maintain a target temperature at which a vapour is generated due to heating of the vapour generating material;
during a second section, the intensity per unit time of power supplied to the heating element has a second value which is higher than the first value;
the heating element is arranged to be broken to thereby break its electrical path when the second value of intensity per unit time of power has been supplied to the heating element a predetermined number of times.

2. The inhalation system according to claim 1, wherein the heating element has a weakened part having a higher electrical resistance than other parts of the heating element, and the weakened part is arranged to be broken when the second value of intensity per unit time of power has been supplied to the heating element said predetermined number of times.

3. The inhalation system according to claim 2, wherein the weakened part has a smaller cross-sectional area than other parts of the heating element.

4. The inhalation system according to claim 2, wherein the weakened part comprises a first material and the other parts of the heating element comprise a second material having a lower electrical resistance than the first material.

5. The inhalation system according to claim 1, wherein the heating element comprises an inductively heatable susceptor.

6. The inhalation system according to claim 5, wherein the inductively heatable susceptor comprises a ring-shaped susceptor including a non-concentric aperture or a slit.

7. The inhalation system according to claim 1, wherein the inductively heatable susceptor comprises a tubular susceptor formed by a wrapped sheet having free edges which are connected by a joint, the joint having an electrical resistance which is higher than an electrical resistance of the sheet.

8. The inhalation system according to claim 1, wherein:
the controller is configured to provide a power supply profile comprising one first section and one second section which occurs before the first section and during which the vapour generating material is heated to the target temperature; and
the heating element is arranged to be broken to thereby break its electrical path during a second instance of the second section when the second value of intensity per unit time of power is supplied to the heating element for a second time.

9. The inhalation system according to claim 1, wherein:
the controller is configured to provide a power supply profile comprising one first section and one second section which occurs after the first section; and
the heating element is arranged to be broken to thereby break its electrical path during a first instance of the second section when the second value of intensity per unit time of power is supplied to the heating element for a first time.

10. The inhalation system according to claim 1, wherein:
the controller is configured to provide a power supply profile comprising a plurality of said first and second sections; and
the heating element is arranged to be broken to thereby break its electrical path after a predetermined number of instances of the second section when the second value of intensity per unit time of power has been supplied to the heating element a predetermined number of times.

11. An inhalation device, for use with a vapour generating article comprising a vapour generating material and a heating element, for generating a vapour for inhalation by a user, the inhalation device including a controller, wherein:
the controller is configured to provide a power supply profile adapted for a single use of the vapour generating article and having at least two sections with differing values of intensity per unit time of power supplied, in use, to the heating element in which;
during a first section, the intensity per unit time of power supplied, in use, to the heating element has a first value arranged to maintain a target temperature at which a vapour is generated due to heating of the vapour generating material;
during a second section, the intensity per unit time of power supplied, in use, to the heating element has a second value which is higher than the first value; and
the heating element is arranged to be broken to thereby break its electrical path when the second value of intensity per unit time of power has been supplied to the heating element a predetermined number of times.

12. A vapour generating article comprising a non-liquid vapour generating material and a heating element having a weakened part which is arranged to be broken at the end of a first use or at the beginning of a second use of the article.

13. The vapour generating article according to claim 12, wherein the weakened part has a higher electrical resistance than other parts of the heating element.

14. The vapour generating article according to claim 13, wherein the weakened part comprises a first material and the other parts of the heating element comprise a second material having a lower electrical resistance than the first material.

15. The vapour generating article according to claim 12, wherein the weakened part has a smaller cross-sectional area than other parts of the heating element.
